(19) United States
(12) Patent Application Publication
(10) Pub. No.: US 2010/0271804 A1
(43) Pub. Date: Oct. 28, 2010

(54) MODULAR LIGHTING DEVICE KIT

(76) Inventor: Jonathan E. Levine, New York, NY (US)

Correspondence Address: THEODORE W. BAKER, 612 Stinson St, Independence, OR, 97351, US

(21) Appl. No.: 12/428,027

(22) Filed: Apr. 22, 2009

(51) Int. Cl. F21V 21/30; F21V 21/00

(52) U.S. Cl. 362/35; 362/217.17

(57) ABSTRACT

A modular lighting device kit is disclosed. The kit can include first and second elongated light-source modules that contain light-emitting diodes. The elongated light-source modules can be physically and electrically connectable either directly or through one or more intervening elements. This connection can be made without the use of tools, such as via coaxial electrical couplings. When connected to each other, the elongated light-source modules can be rotatable around rotation axes parallel to their long axes. In addition, when connected to a power source, power for the second elongated light-source module can flow through the first elongated light-source module. The modular lighting device kit also can include a base module with a power switch. When assembled, a mounting clip shaped to wrap around a portion of the first elongated light-source module can be used to hold the first elongated light-source module in place without restricting its rotation.

### FIELD

This disclosure concerns modular lighting device kits, such as modular lighting device kits including rotatable, elongated light-source modules.

### BACKGROUND

Many track lighting applications require customization. For example, providing lighting under a set of kitchen cabinets can require tracks of custom length with bends or angles at custom locations. Modular lighting systems are a good choice for use in these applications, because they provide versatility without the high cost of custom construction. A typical modular lighting system includes a series of identical or differing modules that can be easily interconnected by an end user to achieve a wide variety of configurations. For example, a modular lighting system may allow an end user to connect straight and angled modules to form a track that matches the path of the underside of a particular set of kitchen cabinets.

One example of a known modular lighting system is disclosed in U.S. Pat. No. 4,639,841 (Salestrom). Salestrom discloses “a plurality of elongated light modules” each having “a female plug portion on one end thereof and a male plug portion on the other end thereof.” Salestrom, abstract. These light modules can be “selectively connected in an end-to-end relationship to achieve the desired light length.” Salestrom, abstract. As another example, U.S. Pat. No. 7,207,696 (Lin) discloses a lighting device in which “[m]ore than one lamp bank can be mounted to [a] lamp holder.” Lin, column 4, lines 45-46. Each of these “lamp bank[s] can be independently rotated . . . to adjust the light projecting direction thereof.” Lin, column 4, lines 46-48. The modular lighting systems disclosed in Salestrom and Lin are useful examples, but they have significant limitations that will become apparent in view of the disclosure below.

### SUMMARY

Disclosed herein are embodiments of a modular lighting device kit. The modular lighting device kit can include first and second elongated light-source modules each having a long axis between a first end and a second end and each including lighting elements, such as two or more light-emitting diodes. The first and second elongated light-source modules can be physically and electrically connectable either directly or through one or more intervening elements. This connection can be made, for example, without the use of tools. When connected to a power source, power for the second elongated light-source module can flow through the first elongated light-source module. In some disclosed embodiments, the second end of the first elongated light-source module and the first end of the second elongated light-source module each include a male or female half of a coaxial electrical coupling. When connected to each other, either directly or through one or more intervening elements, the first and second elongated light-source modules can be rotatable through rotation ranges (e.g., 360°) around rotation axes parallel to their long axes.

When directly connected, a rotation interface between the first and second elongated light-source modules can be the same as an interface between the male or female half of the coaxial electrical coupling of the second end of the first elongated light-source module and the male or female half of the coaxial electrical coupling of the first end of the second elongated light-source module. Alternatively, the modular lighting device kit can include a coupler module connectable between the first and second elongated light-source modules, such as between the second end of the first elongated light-source module and the first end of the second elongated light-source module. The coupler module can have a first end with a male or female half of a coaxial electrical coupling and a second end with a male or female half of a coaxial electrical coupling. Between these ends, the coupler module can define an angle. For example, when the first elongated light-source module, the coupler module, and the second elongated light-source module are connected, the long axis of the first elongated light-source module can be offset relative to the long axis of the second elongated light-source module by the angle defined by the coupler module.

The disclosed modular lighting device kit also can include a third elongated light-source module having a long axis between a first end and a second end. The first end of the third elongated light-source module can include a male or female half of a coaxial electrical coupling. A coupler module including three ends, each with a male or female half of a coaxial electrical coupling, can be included for connecting the second end of the first elongated light-source module to the first end of the second elongated light-source module and the first end of the third elongated light-source module.

The light-source modules in embodiments of the disclosed modular lighting device kit can include light-emitting diodes oriented at different angles. For example a first light-emitting diode can be oriented at a first angle in a plane perpendicular to the long axis of the elongated light-source module, and a second light-emitting diode can be oriented at a second angle in the plane perpendicular to the long axis of the elongated light-source module. The first angle can be separated from the second angle, for example, by between 60° and 180°. Multiple light-emitting diodes oriented at substantially the same angle can be positioned, for example, in separate rows extending substantially parallel to the long axis of the elongated light-source module.

Some embodiments of the disclosed modular lighting device kit include a base module with a power switch. Like the elongated light-source modules, the base module can include a coupling element, such as a male or female half of a coaxial electrical coupling. In this way, the base module can be physically and electrically connectable either directly or through one or more intervening elements to the first elongated light-source module, such as the first end of the first elongated light-source module. The base module can include a battery compartment as an alternative or exclusive power supply and a mounting surface to aid in mounting the overall modular lighting device kit. Some disclosed embodiments also include a mounting clip shaped to wrap around a portion of the first elongated light-source module (e.g., in a manner that does not restrict rotation of the first elongated light-source module around its rotation axis). When the first elongated light-source module is connected to the base module and the mounting clip is connected to the first elongated light-source module, the base module and the mounting clip can have coplanar mounting surfaces.

### BRIEF DESCRIPTION OF THE DRAWINGS

FIG. 1 is a perspective view of a first embodiment of the disclosed modular lighting device kit assembled in a first configuration, as viewed from the top and one side thereof.

FIG. 2 is a back profile view of the modular lighting device kit of FIG. 1 assembled in the first configuration.

FIG. 3 is a top plan view of the modular lighting device kit of FIG. 1 assembled in the first configuration.

FIG. 4 is a front profile view of the modular lighting device kit of FIG. 1 assembled in the first configuration.

FIG. 5 is a bottom plan view of the modular lighting device kit of FIG. 1 assembled in the first configuration.

FIG. 6 is a first end profile view of the modular lighting device kit of FIG. 1 assembled in the first configuration.

FIG. 7 is a second end profile view of the modular lighting device kit of FIG. 1 assembled in the first configuration.

FIG. 8 is a first end profile view of a light-source module from the modular lighting device kit of FIG. 1.

FIG. 9 is a perspective view of the first end of the light-source module of FIG. 8, as viewed from the top and one side thereof.

FIG. 10 is a second end profile view of a light-source module from the modular lighting device kit of FIG. 1.

FIG. 11 is a perspective view of the second end of the light-source module of FIG. 10, as viewed from the top and one side thereof.

FIG. 12 is a front profile view of a mounting clip from the modular lighting device kit of FIG. 1.

FIG. 13 is a perspective view of the base module from the modular lighting device kit of FIG. 1 as viewed from the top and one side thereof.

FIG. 14 is a bottom plan view of the base module from the modular lighting device kit of FIG. 1 with the mounting plate removed.

FIG. 15 is a side profile view of the mounting plate of the base module from the modular lighting device kit of FIG. 1.

FIG. 16 is an exploded top plan view of the modular lighting device kit of FIG. 1 including a straight connector and an additional light-source module and assembled in a second configuration.

FIG. 17 is an exploded top plan view of the modular lighting device kit of FIG. 1 including an angle connector and two additional light-source modules and assembled in a third configuration.

FIG. 18 is an exploded top plan view of the modular lighting device kit of FIG. 1 including a branch connector and three additional light-source modules and assembled in a fourth configuration.

FIG. 19 is a side profile view of an alternative light-source module with two rows of lighting elements on two light-source module circuit boards.

FIG. 20 is a cross sectional view of the light-source module shown in FIG. 19 taken along the line 20-20 in FIG. 19.

FIG. 21 is a side profile view of an alternative light-source module with three rows of lighting elements on three light-source module circuit boards.

FIG. 22 is a cross sectional view of the light-source module shown in FIG. 21 taken along the line 22-22 in FIG. 21.

FIG. 23 is a bottom plan view of an alternative base module with a mounting plate and battery compartment cover removed to expose a battery compartment.

### DETAILED DESCRIPTION

Throughout this disclosure, the singular terms “a,” “an,” and “the” include plural referents unless the context clearly indicates otherwise. Similarly, the word “or” is intended to include “and” unless the context clearly indicates otherwise. Directional terms, such as “upper,” “lower,” “front,” “back,” “vertical,” and “horizontal,” are used herein to express and clarify the relationship between various elements. It should be understood that such terms do not denote absolute orientation (e.g., a “vertical” component can become horizontal by rotating the device).

Described herein are embodiments of a modular lighting device kit. Conventional modular lighting device kits typically include lighting elements oriented at one angle and do not allow for adjustment of the direction of emitted light. In contrast, embodiments of the disclosed modular lighting device kit can include lighting elements oriented at multiple angles and/or features that allow for adjustment of the direction of emitted light. This is useful for a variety of applications. For example, the angle of emitted light can be adjusted during assembly to suit a particular environment. In some disclosed embodiments, the angle of emitted light also can be adjusted after assembly. For example, these embodiments can allow an end user to adjust the angle of emitted light as needed without disassembling the system. Some embodiments of the disclosed modular lighting device kit also include advantageous configurations of lighting elements, including multiple rows of lighting elements oriented at different angles to achieve greater light distribution. Combined mechanical and electrical connections between the modules of some disclosed embodiments further enhance the versatility of these embodiments and generally facilitate their convenient assembly and use.

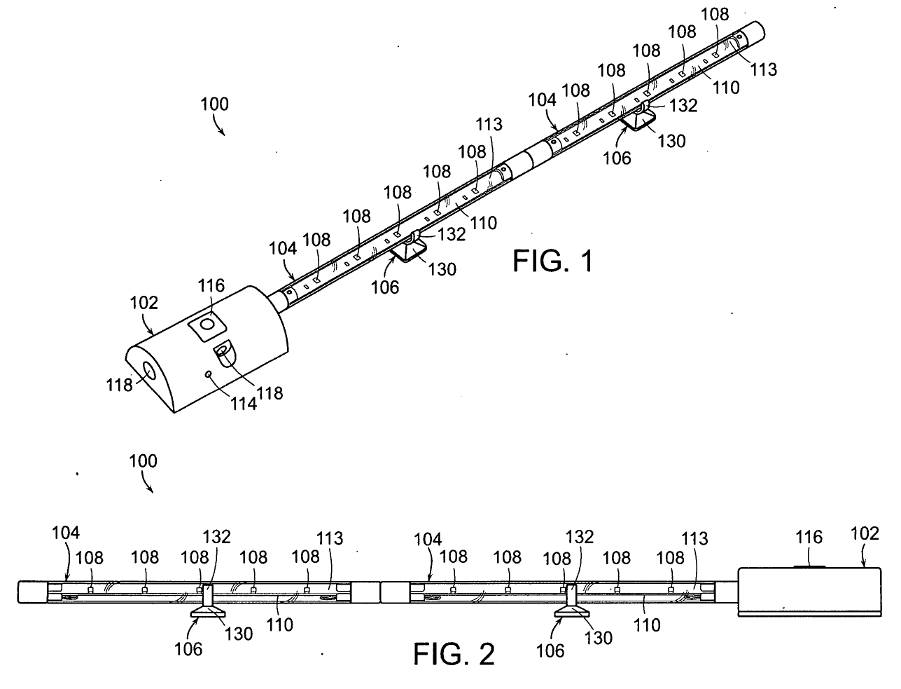

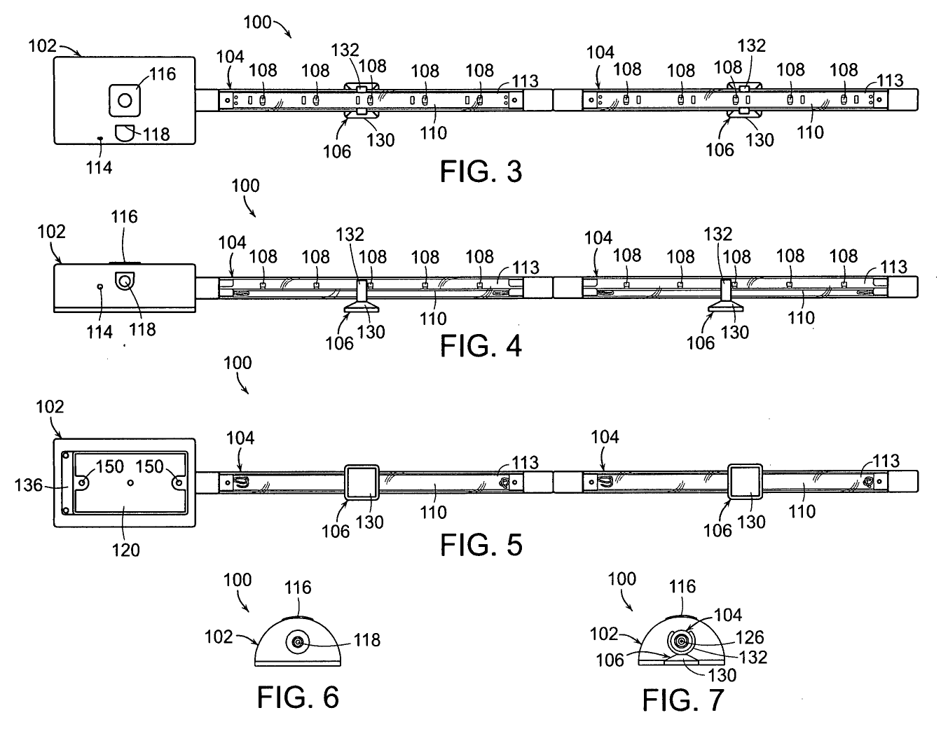

FIGS. 1-18 illustrate a first embodiment of the disclosed modular lighting device kit. In FIGS. 1-7, the illustrated modular lighting device kit 100 is arranged in a first configuration including a base module 102, two light-source modules 104, and two mounting clips 106. As discussed in greater detail below, the lighting device kit 100 can be assembled in a variety of other configurations, some of which include alternative and/or additional modules. The modules of embodiments of the disclosed modular lighting device kit can be any size, but typically are compact. The modules also can have a variety of shapes. In the illustrated modular lighting device kit 100, the base module 102 is shaped as a half cylinder and the light-source modules 104 are shaped as full cylinders. In other embodiments, corresponding modules can be shaped, for example, as triangular prisms, spheroids, or cuboids.

The light-source modules 104 each include five lighting elements 108 positioned on a light-source module circuit board 110. The lighting elements 108 of each light-source module 104 are arranged in a row parallel to the length of the light-source module. In other embodiments, each light-source module can include one, two, three, four, six, seven, eight, nine, ten, or a greater number of lighting elements. In embodiments with multiple lighting elements per light-source module, the lighting elements can be arranged in a variety of configurations. For example, the lighting elements can be arranged in two or more rows that are substantially parallel to the length of the light-source module or in one or more rows that are substantially perpendicular to the length of the light-source module. The lighting elements also can be arranged, for example, in clusters or in a staggered pattern.

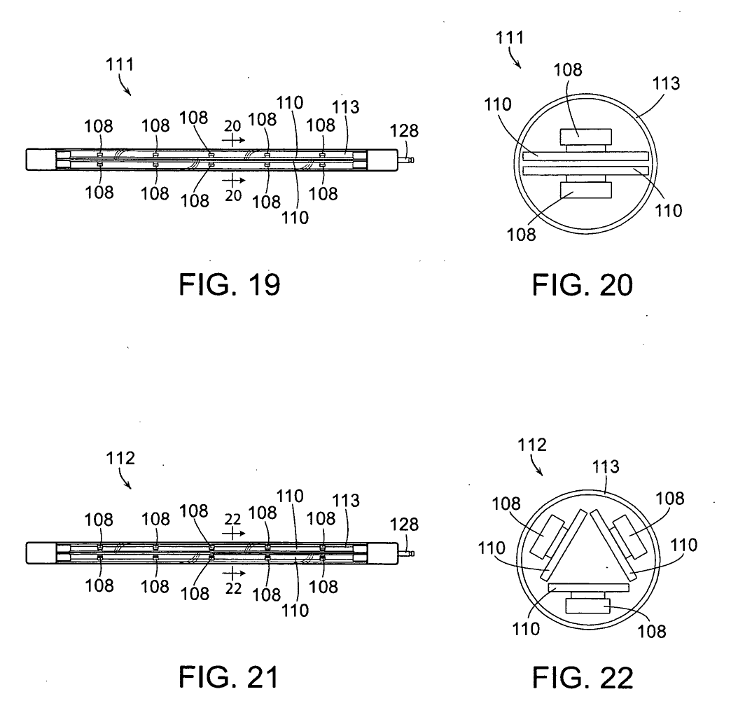

FIGS. 19-20 illustrate a first alternative light-source module 111 including two light-source module circuit boards 110 positioned back-to-back. FIGS. 21-22 illustrate a second alternative light-source module 112 including three light-source module circuit boards 110 positioned with their backs forming a triangle. Each of the light-source module circuit boards 110 shown in FIGS. 19-22 includes a row of lighting elements 108. The rows of lighting elements 108 in the first and second alternative light-source modules 111, 112 are oriented at angles separated by 180° and 120°, respectively, in planes perpendicular to the long axes of the first and second alternative light-source modules. Other embodiments can include light-source modules with lighting elements oriented at angles separated, for example, by other radial values, such as other radial values between 60° and 180° or between 90° and 180°. Due to the larger number of lighting elements 108, the first and second alternative light-source modules 111, 112 have greater light output than the light-source modules 104 shown in FIGS. 1-18. The positioning of the lighting elements 108 within the first and second alternative light-source modules 111, 112 shown in FIGS. 19-22 also allows for greater radial distribution of light output relative to the light-source modules shown in FIGS. 1-18.

In the illustrated modular lighting device kit 100, the lighting elements 108 are white light-emitting diodes. In other embodiments, the lighting elements can be incandescent, fluorescent, halogen, xenon, neon, or some other commercially available lighting type. Light-emitting diodes are particularly well suited for use in disclosed embodiments due to their compact size, low power demand, low heat output, long life, and high durability. Instead of white light-emitting diodes, other embodiments can include light-emitting diodes of another color, such as red, orange, yellow, green, or blue.

The lighting elements 108 and light-source module circuit boards 110 are enclosed behind windows 113. The windows 113 fully encircle the light-source modules 104 and extend along the majority of the lengths of the light-source modules. In other embodiments, the windows can encircle a smaller portion of the light-source modules. The windows also can have different lengths. The lengths of the windows can be, for example, between about 40% and about 100% of the lengths of the corresponding light-source modules, such as between about 60% and about 99%, or between about 80% and about 98%. In the illustrated modular lighting device kit 100, the windows 113 are made of substantially transparent plastic. Other embodiments can include windows made of glass or another substantially transparent material. Opaque frame portions of the disclosed modular lighting device kit 100 are also made of plastic. In other embodiments, opaque frame portions can be made of metal, resin composite, or another material with suitable strength characteristics.

Embodiments of the disclosed modular lighting device kit can include a base module, such as the base module 102 shown in FIGS. 1-7 and 13-18. When included, the base module typically receives power from an external or battery power source and/or provides power control to other modules. The base module also can include lighting elements. As best shown in FIGS. 1 and 13, the base module 102 of the modular lighting device kit 100 includes a power port 114, a power button 116, three base-module jacks 118, and a mounting plate 120. A compatible power cord (not shown) including a DC adaptor can be plugged at one end into the power port 114 and at the other end into a standard wall receptacle. Rather than including a power port for use with a detachable cord, other embodiments can be configured to be hard wired to a wall circuit. Embodiments configured for use with a cord can include a DC adaptor along the cord, a DC adaptor within a module (e.g., within the base module), or no DC adaptor, depending on the power supply requirements.

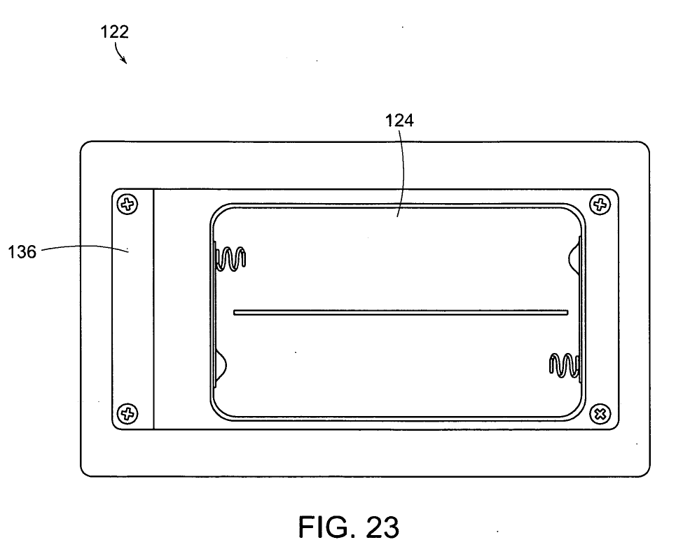

Embodiments of the disclosed modular lighting device kit can be configured for the exclusive or optional use of battery power. FIG. 23 illustrates an alternative base module 122 including a battery compartment 124. The illustrated battery compartment 124 is configured to hold two AA batteries connected in series. Other embodiments powered exclusively or optionally by batteries can include any number, type, and arrangement of batteries, such as two AAA batteries in parallel or one nine-volt battery directly connected to the circuit. Embodiments that include an optional battery power supply can be configured to automatically cease power draw from the batteries when an external power source is active (e.g., when a cord is plugged into a wall receptacle). An indicator light also can be included to readily indicate to an end user that power is being drawn from the external power source. These embodiments also can include a manual power supply switch to toggle power draw between the batteries and the external power source.

The power button 116 controls power distribution to the base-module jacks 118. When the power button 116 is pressed, it translates the action to activate a switch (not shown) on a base-module circuit board (not shown). Instead of a power button, other disclosed embodiments can include another type of power control, such as a toggle switch, a rocker switch, a slide switch, or a dial. Embodiments of the disclosed modular lighting device kit also can include more than one power control, such as multiple power controls on the base module, each corresponding to a separate base-module jack or a separate power control on each of several light-source modules.

In the illustrated modular lighting device kit 100, the power button 116 simultaneously activates or deactivates all of the lighting elements 108 in any light-source modules 104 connected directly or indirectly to the base-module jacks 118 (i.e., all lighting elements within the assembly). Other embodiments can include a different control mechanism. Some disclosed embodiments include a power control configured to change the level of light intensity. For example, a first press of a power button can turn on associated lighting elements, a second press of the power button can decrease the light intensity, and a third press of the power button can turn off the associated lighting elements. The power control also can be configured to cycle between the activation of different lighting elements from among a plurality of lighting elements. For example, a first press of a power button can turn on the lighting elements in any light-source modules connected to a first of the base-module jacks, a second press of the power button can turn on the lighting elements in any light-source modules connected to a second of the base-module jacks, a third press of the power button can turn on the lighting elements in any light-source modules connected to a third of the base-module jacks, and a fourth press of the power button can turn off all the lighting elements. The functionality of cycling the light intensity or the number of illuminated lighting elements is achieved, for example, by including a commercially available dimmer or selector switch on the base-module circuit board.

Some embodiments of the disclosed modular lighting device kit include a remote control unit in addition to or instead of an integral power control switch. The remote control unit can include a power button, as described above, and a commercially available transmitter (e.g., an IR or RF transmitter). One or more corresponding mounted modules can include a commercially available receiver (e.g., an IR or RF receiver). In some embodiments, a single remote control unit is capable of controlling multiple assemblies of mounted modules. For example, the remote control unit can include a channel selector, such as a slide switch, capable of toggling the command or frequency generated in response to pressing a power button on the remote control unit. Two or more corresponding assemblies of mounted modules can include similar channel selectors capable of toggling the receiving command or frequency.

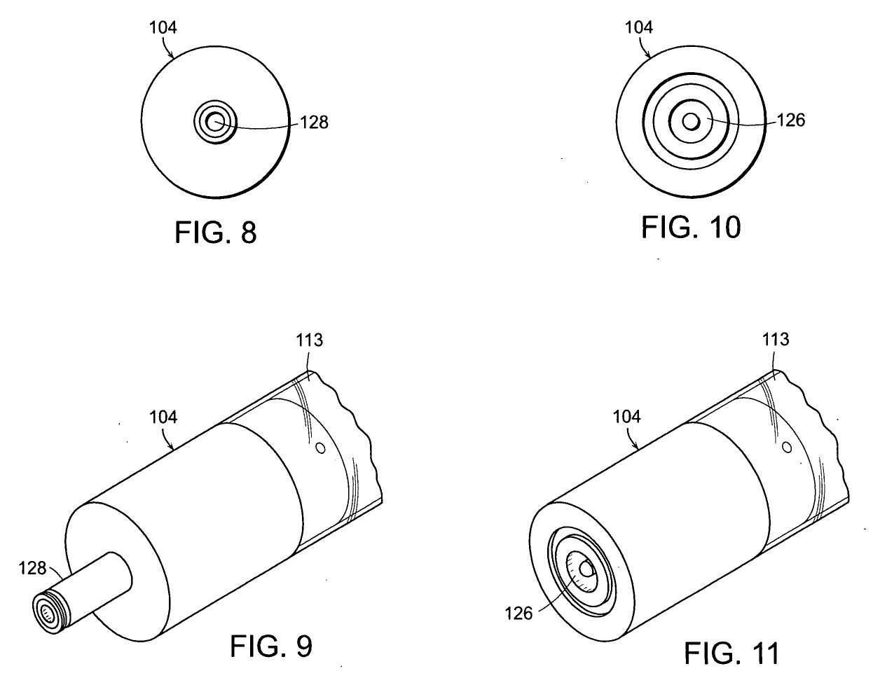

As shown in FIGS. 8-11, the light-source modules 104 each include a light-source module jack 126 at one end and a plug 128 at the opposite end. Each plug 128 is configured to fit within one of the base-module jacks 118 or within a light-source module jack 126 of a separate light-source module 104. When joined, a plug 128 and a corresponding jack form a coaxial coupling that provides both electrical and mechanical connection between two adjacent modules. The shape of the coaxial coupling, however, permits free rotation of adjacent modules around a rotation axis parallel to the long axis of the plug 128. For example, when the base module 102 and the light-source modules 104 are connected in the first configuration shown in FIGS. 1-7, the light-source modules each can be rotated 360° relative to adjacent modules. This allows the angle of emitted light to be easily adjusted during or after assembly of the overall modular lighting device kit 100. Due to a tight fit within the coaxial couplings, the rotation can occur without breaking the electrical or mechanical connections. Furthermore, the rotation interface between adjacent modules is also the electrical interface, so the rotation does not result in tangling wires.

The coupling elements of various modules of the disclosed modular lighting device kit typically are compatible so that the modules can be arranged in a variety of configurations. In the illustrated modular lighting device kit 100, the plugs 128 are commercially available DC plugs generally shaped as elongated cylinders and the base-module and light-source module jacks 118, 126 are commercially available jacks generally shaped as corresponding cylindrical recesses. In other embodiments, the coupling elements can have different forms. For example, the coupling elements can be generally shaped as spheroids and corresponding spheroid recesses. In embodiments in which the light-source modules do not rotate, the coupling elements can be shaped, for example, as male/female pairs of triangular prisms, cuboids, or other multiple-sided prisms. The types and positions of the coupling elements can be interchanged in alternative embodiments. For example, in some disclosed embodiments, the light-source modules include two plugs or two jacks rather than one plug and one jack. Similarly, the base-module jacks can be substituted with plugs or with a combination of plugs and jacks. The light-source modules and base module also can include different numbers of coupling elements, such as one, two, three, four, five, or a greater number of coupling elements.

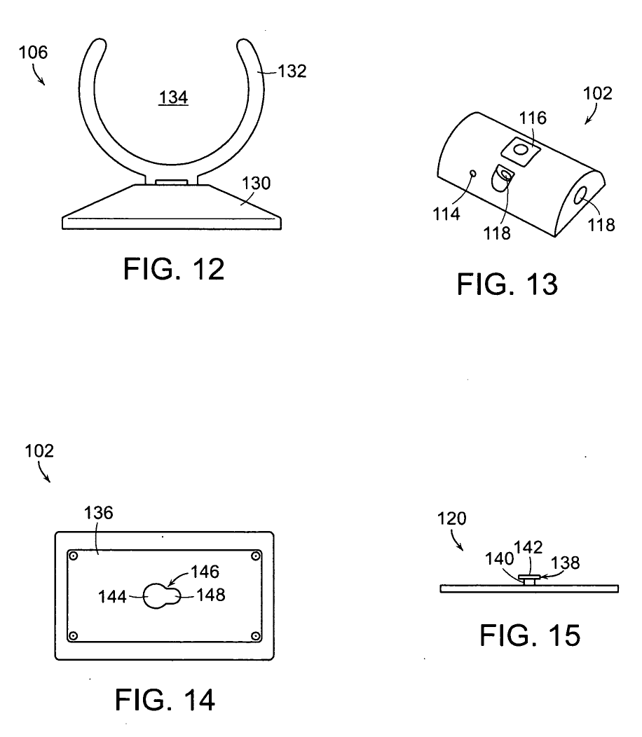

FIG. 12 is a front profile view of one of the mounting clips 106. When attached, the mounting clips 106 hold the light-source modules 104 in place a set distance from a mounting surface. Each mounting clip 106 includes a base 130 and a cradle 132 defining an opening 134. To connect a mounting clip 106 to a light source module 104, the light-source module can be forced into the opening 134 until the cradle 132 deforms slightly and then snaps back into place around the cross-sectional perimeter of the light-source module. Alternatively, an end of the light-source module 104 can be inserted into the opening 134 and the mounting clip 106 can then be moved into position along the length of the light-source module. A fastening material (e.g., adhesive material, magnetic material, or hook-and-loop material) can be included on a bottom surface of the mounting clips 106 to allow the mounting clips to be attached to a mounting surface. Since they are not fixed to the light-source modules 104, the mounting clips 106 can be positioned and repositioned at any point along the lengths of the light-source modules. The lack of a rigid connection also prevents the mounting clips 106 from interfering with rotation of the light-source modules 104. Other embodiments of the disclosed modular lighting device kit can have no mounting clips or differently configured mounting elements for the light-source modules. For example, in some disclosed embodiments, the mounting clips include a ring instead of a cradle.

When included, a base module, such as the base module 102, can provide an anchor for the overall modular lighting device kit. The mounting plate 120 of the base module 102 assists with securing the base module to a mounting surface. The bottom surface of the mounting plate 120 is substantially coplanar with the bottom surfaces of the bases 130 of the mounting clips 106. As shown in FIGS. 5, 14, and 15 the mounting plate 120 is positioned within a mounting-plate recess 136. A post 138 allows the mounting plate 120 to be readily attached to or detached from the base module 102. The post 138 includes a neck 140 and a flanged head 142. To attach the mounting plate 120 to the base module 102, the post 138 is inserted into a wide portion 144 of a post hole 146 in the base module. The mounting plate 120 then is moved sideways to shift the neck 140 of the post 138 into a narrow portion 148 of the post hole 146. The flanged head 142 of the post 138 does not fit through the narrow portion 148 of the post hole 146, so the mounting plate 120 is securely held in place. To detach the mounting plate 120 from the base module 102, the mounting plate can be moved sideways in the opposite direction until the flanged head 142 of the post 138 moves back into alignment with the wide portion 144 of the post hole 146.

In a typical installation, the mounting plate 120 is permanently connected to a mounting surface, such as a wall or the underside of a cabinet. Screws can be installed through mounting holes 150 in the mounting plate 120 to form this connection. The remainder of the base module 102 then can be attached to the mounting plate 120 via the interlocking post 138 and post hole 146. In embodiments including a battery compartment, the battery compartment can be positioned behind the mounting plate. In these embodiments, a post or post hole can be included on a battery-compartment cover or on a portion of the mounting-plate recess separate from the battery compartment. When an end user requires access to the battery compartment, the base module can be readily detached from the mounting plate without the need to break any permanent connection between the base module and the mounting surface. Embodiments of the disclosed modular lighting device kit including a base module also can be used without a mounting plate. For example, fastening material (e.g., adhesive material, magnetic material, or hook-and-loop material) can be positioned on the bottom surface of the base module. This fastening material can be used to directly connect the base module to a mounting surface.

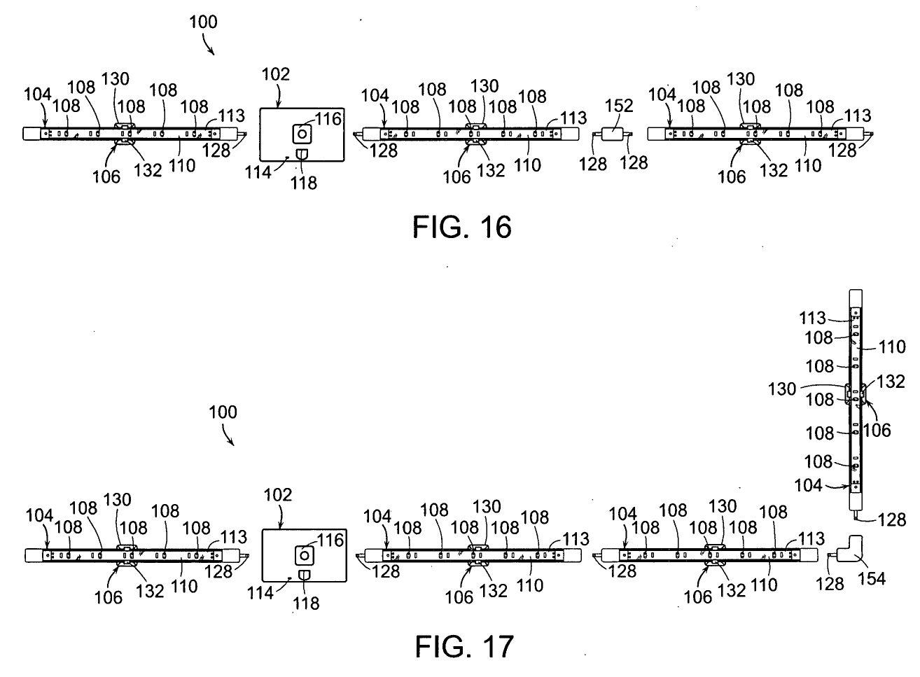

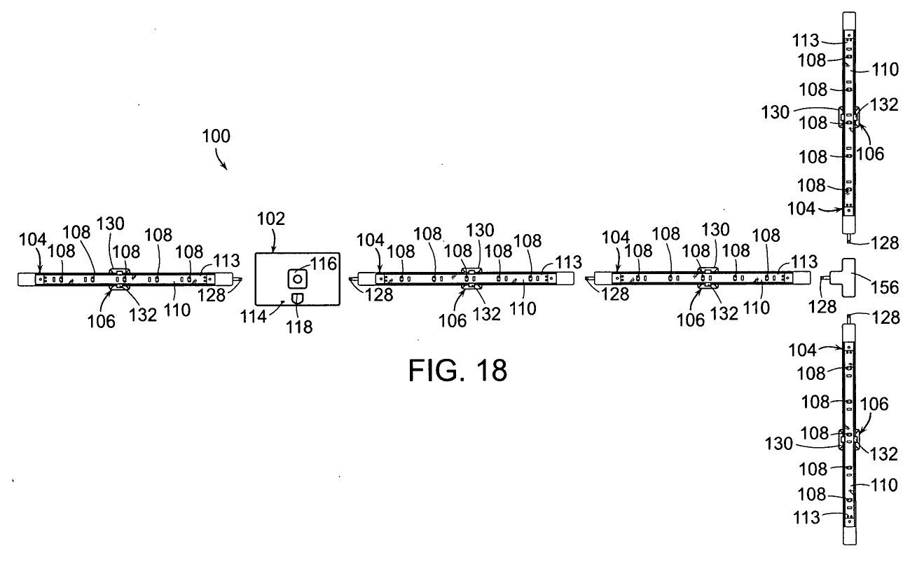

As shown in FIGS. 1-7, the first configuration of the modular lighting device kit 100 includes two light-source modules 104 connected in series to one of the base-module jacks 118. A wide variety of other configurations are possible. These other configurations can include different types of modules, different numbers of modules, and/or different arrangements of modules. For example, FIG. 16 shows a second configuration similar to the first configuration, but with an additional light-source module 104 connected to another one of the base-module jacks 118 and with a straight connector 152 between the two light-source modules 104 in series. FIG. 17 shows a third configuration similar to the first configuration, but with an additional light-source module 104 connected to another one of the base-module jacks 118 and with an angle connector 154 connected at one end to the two light source modules in series and at the other end to another light-source module. FIG. 18 shows a fourth configuration similar to the third configuration, but with a branch connection 156 instead of the angle connector 152 and with an additional light-source module connected to the branch connector.

Some embodiments of the disclosed modular lighting device kit include more than one type of light-source module. For example, these embodiments can include light-source modules with different lighting element configurations (e.g., the first and second alternative light-source modules shown in FIGS. 19-22), light-source modules of different lengths, angled light-source modules, and/or branched light-source modules.

Some of the light-source modules, such as angled and branched light-source modules, can be fixed (i.e., not able to rotate). The base modules in embodiments of the modular lighting device kit also can be substituted. For example, the base module 102 in the lighting device kit 100 can be replaced with a light-source module including a mechanism for receiving power, such as a mechanism similar to the power port 114 or the battery compartment 124.

Embodiments of the disclosed modular lighting device kit can include a variety of features in addition to or in place of those described above and shown in FIGS. 1-23. For example, some embodiments include a sensor that activates and/or deactivates the lighting elements. In some embodiments, this sensor is a light sensor, such as a commercially available light sensor that activates the lighting elements when light from another source is detected. This can be useful for applications in which the disclosed modular lighting device kit is not the primary lighting device for an area. Once the primary lighting device for an area (e.g., an overhead light) is activated, embodiments of the disclosed modular lighting device kit can be configured to activate automatically. In this way, secondary lighting, such as accent lighting, can be activated without the need for manual intervention. By the same principle, the disclosed modular lighting device kit can be activated by a motion sensor, such as a commercially available motion sensor. Embodiments including a sensor also can include a manual override switch to deactivate the sensor when automatic operation is not desirable. The manual override switch can be, for example, a commercially available switch that switches the flow of electrical current between a circuit including the sensor and a circuit not including the sensor.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. I therefore claim as my invention all that comes within the scope and spirit of these claims.

I claim:

1. A modular lighting device kit, comprising:
a first elongated light-source module having a long axis between a first end and a second end and including two or more light-emitting diodes, the second end of the first elongated light-source module including a male or female half of a coaxial electrical coupling; and
a second elongated light-source module having a long axis between a first end and a second end and including two or more light-emitting diodes, the first end of the second elongated light-source module including a male or female half of a coaxial electrical coupling, wherein the first and second elongated light-source modules are physically and electrically connectable either directly or through one or more intervening elements such that the first and second elongated light-source modules are rotatable around rotation axes parallel to the long axes of the first and second elongated light-source modules, respectively, and, when connected to a power source, power for the second elongated light-source module flows through the first elongated light-source module.

2. The modular lighting device kit according to claim 1, wherein the male or female half of the coaxial electrical coupling of the second end of the first elongated light-source module is directly connectable to the male or female half of the coaxial electrical coupling of the first end of the second elongated light-source module, and a rotation interface between the first elongated light-source module and the second elongated light-source module is an interface between the male or female half of the coaxial electrical coupling of the second end of the first elongated light-source module and the male or female half of the coaxial electrical coupling of the first end of the second elongated light-source module.

3. The modular lighting device kit according to claim 1, wherein, when connected, the first and second elongated light-source modules each are rotatable 360° around their respective rotation axes.

4. The modular lighting device kit according to claim 1, wherein the first and second elongated light-source modules are connectable without the use of tools.

5. The modular lighting device kit according to claim 1, further comprising a coupler module having a first end with a male or female half of a coaxial electrical coupling and a second end with a male or female half of a coaxial electrical coupling, wherein the coupler module is connectable between the second end of the first elongated light-source module and the first end of the second elongated light-source module.

6. The modular lighting device kit according to claim 5, wherein the coupler module defines an angle, and, when the first elongated light-source module, the coupler module, and the second elongated light-source module are connected, the long axis of the first elongated light-source module is offset relative to the long axis of the second elongated light-source module by the angle.

7. The modular lighting device kit according to claim 5, further comprising a third elongated light-source module having a long axis between a first end and a second end, wherein the first end of the third elongated light-source module includes a male or female half of a coaxial electrical coupling, the coupler module has a third end with a male or female half of a coaxial electrical coupling, and the coupler module is connectable between the second end of the first elongated light-source module, the first end of the second elongated light-source module, and the first end of the third elongated light-source module.

8. The modular lighting device kit according to claim 1, further comprising a base module having a power switch and a male or female half of a coaxial electrical coupling, wherein the base module and the first elongated light-source module are physically and electrically connectable either directly or through one or more intervening elements.

9. The modular lighting device kit according to claim 8, wherein the base module includes a battery compartment.

10. The modular lighting device kit according to claim 8, further comprising a mounting clip shaped to wrap around a portion of the first elongated light-source module, wherein the base module and the mounting clip include coplanar mounting surfaces when the first elongated light-source module is connected to the base module and the mounting clip is connected to the first elongated light-source module.

11. The modular lighting device kit according to claim 10, wherein the mounting clip does not restrict rotation of the first elongated light-source module around its rotation axis.

12. A modular lighting device kit, comprising:
a first elongated light-source module having a long axis between a first end and a second end and including a first light-emitting diode oriented at a first angle in a plane perpendicular to the long axis of the first elongated light-source module and a second light-emitting diode oriented at a second angle in the plane perpendicular to the long axis of the first elongated light-source module, the first angle of the first light-emitting diode of the first elongated light-source module being separated from the second angle of the second light-emitting diode of the first elongated light-source module by between 60° and 180°; and
a second elongated light-source module having a long axis between a first end and a second end and including a first light-emitting diode oriented at a first angle in a plane perpendicular to the long axis of the second elongated light-source module and a second light-emitting diode oriented at a second angle in the plane perpendicular to the long axis of the second elongated light-source module, the first angle of the first light-emitting diode of the second elongated light-source module being separated from the second angle of the second light-emitting diode of the second elongated light-source module by between 60° and 180°, wherein the first and second elongated light-source modules are physically and electrically connectable either directly or through one or more intervening elements such that, when connected to a power source, power for the second elongated light-source module flows through the first elongated light-source module.

13. The modular lighting device kit according to claim 12, wherein the first and second light-emitting diodes of the first elongated light-source module are enclosed behind a first window, and the first and second light-emitting diodes of the second elongated light-source module are enclosed behind a second window.

14. The modular lighting device kit according to claim 12, wherein the first and second elongated light-source modules are connectable without the use of tools.

15. The modular lighting device kit according to claim 12, wherein the second end of the first elongated light-source module includes a jack, the first end of the second elongated light-source module includes a plug, the plug is insertable into the jack to physically and electrically connect the first elongated light-source module to the second elongated light-source module such that the second elongated light-source module is rotatable relative to the first elongated light-source module around a rotation axis parallel to the long axis of the second elongated light-source module, and a rotation interface between the first elongated light-source module and the second elongated light-source module is an interface between the plug and the jack.

16. The modular lighting device kit according to claim 15, wherein, when connected, the second elongated light-source module is rotatable 360° around the rotation axis.

17. The modular lighting device kit according to claim 12, wherein the first elongated light-source module includes three or more light-emitting diodes oriented at substantially the first angle of the first light-emitting diode of the first elongated light-source module and positioned in a first row extending substantially parallel to the long axis of the first elongated light-source module, and the second elongated light-source module includes three or more light-emitting diodes oriented at substantially the first angle of the first light-emitting diode of the second elongated light-source module and positioned in a first row extending substantially parallel to the long axis of the second elongated light-source module.

18. The modular lighting device kit according to claim 17, wherein the first elongated light-source module includes three or more light-emitting diodes oriented at substantially the second angle of the second light-emitting diode of the first elongated light-source module and positioned in a second row extending substantially parallel to the long axis of the first elongated light-source module, and the second elongated light-source module includes three or more light-emitting diodes oriented at substantially the second angle of the second light-emitting diode of the second elongated light-source module and positioned in a second row extending substantially parallel to the long axis of the second elongated light-source module.

19. A modular lighting device kit, comprising:
a first elongated light bar having a long axis between a first end and a second end;
a second elongated light bar having a long axis between a first end and a second end; and
coupling means for connecting the first and second elongated light bars such that the first and second elongated light bars are rotatable around rotation axes parallel to the long axes of the first and second elongated light bars, respectively, and, when connected to a power source, power for the second elongated light bar flows through the first elongated light bar.

20. The modular lighting device kit according to claim 19, further comprising mounting means for attaching the first elongated light bar to a mounting surface without restricting rotation of the first elongated light bar around its rotation axis.
